(19) United States
(12) Patent Application Publication
(10) Pub. No.: US 2005/0166405 A1
(43) Pub. Date: Aug. 4, 2005

(54) Cutting tool

(76) Inventor: Mu-Tung Lai, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/770,685

(22) Filed: Feb. 2, 2004

(51) Int. Cl. B26B 13/00

(52) U.S. Cl. 30/229

(57) ABSTRACT

A cutting tool includes a first handle, a second handle, a first jaw, a second jaw and a knife. The second handle is pivotally connected with the first handle. The first jaw is secured to the first handle. The second jaw is secured to the second handle. The knife is attached to the second jaw in a detachable manner.

### FIELD OF INVENTION

The present invention relates to a cutting tool.

### BACKGROUND OF INVENTION

Referring to FIG. 7, a conventional cutting tool includes a first handle 91, a second handle 92, a first jaw 93 and a second jaw 94. The first handle 91 is pivotally connected with the second handle 92 by means of a bolt 943. The first jaw 93 is firmly installed on the first handle 91 by means of two bolts (not numbered). The second jaw 94 is installed on the second handle 92 by means of the bolt 943 and a stop (not shown). The first jaw 93 includes a hollow triangular shear 931 formed at an end, two holders 933 extending from the hollow triangular shear 931 and a groove 932 defined between the holders 933. The second jaw 94 includes a triangular shear 941 formed an end thereof and a knife 942 extending from the triangular shear 941. This conventional cutting tool is used to cut a nozzle extending from a tube containing silicone. The nozzle is put between the knife 942 and the holders 933. Via pivoting the first handle 91 towards the second handle 92, the knife 942 cuts the nozzle held by means of the holders 933. Then the cut nozzle is put between the hollow triangular shear 931 and the triangular shear 941. Again, via pivoting the first handle 91 towards the second handle 92, hollow triangular shear 931 and the triangular shear 941 cooperate to do a V-shaped cut in the nozzle. The knife 942 will be abraded due to cutting for a long time; however, the knife 942 alone cannot be replaced. Hence, the whole cutting tool has to be replaced.

The present invention is therefore intended to obviate or at least alleviate the problems encountered in prior art.

### SUMMARY OF INVENTION

The primary objective of the present invention is to provide a cutting tool for replacing the knife convenient and reducing cost.

A cutting tool includes a first handle, a second handle, a first jaw, a second jaw and a knife. The second handle is pivotally connected with the first handle. The first jaw is secured to the first handle. The second jaw is secured to the second handle. The knife is attached to the second jaw in a detachable manner.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the drawings.

FIG. 1 is a perspective view of a cutting tool according to the preferred embodiment of the present invention.

FIG. 2 is an exploded view of the cutting tool.

FIG. 3 is a side view of the cutting tool in a position to ready for cutting a nozzle of a tube.

FIG. 4 is a side view of the cutting tool in a position ready for opening a cap of a can.

FIG. 5 is a top view of the cutting tool with a knife attached to a jaw.

FIG. 6 is similar to FIG. 5 but shows the knife removed from the jaw.

FIG. 7 is a perspective view of a conventional cutting tool.

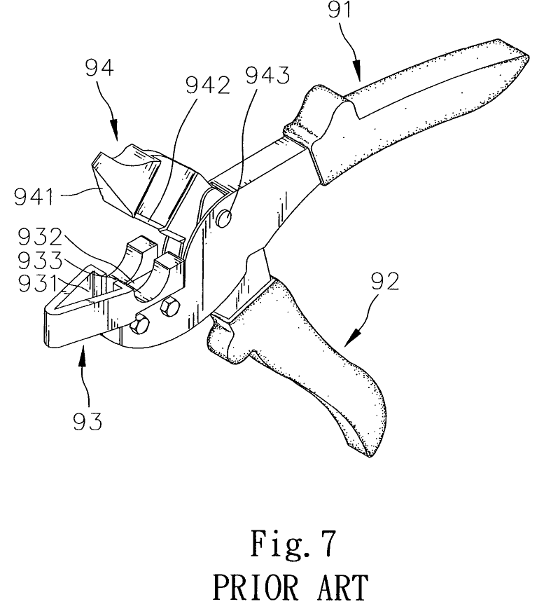

### DETAILED DESCRIPTION OF PREFERRED EMBODIMENT

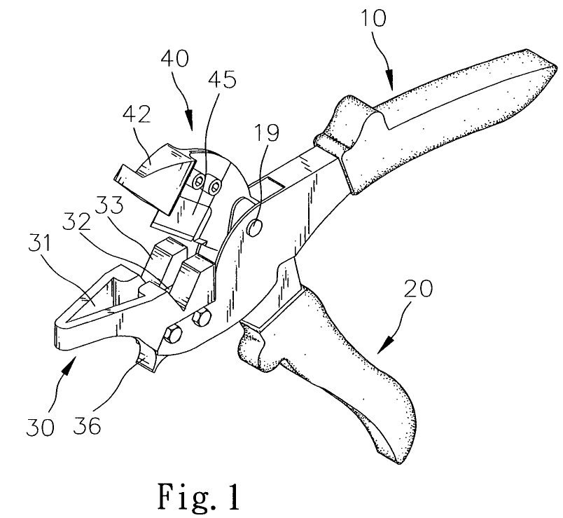

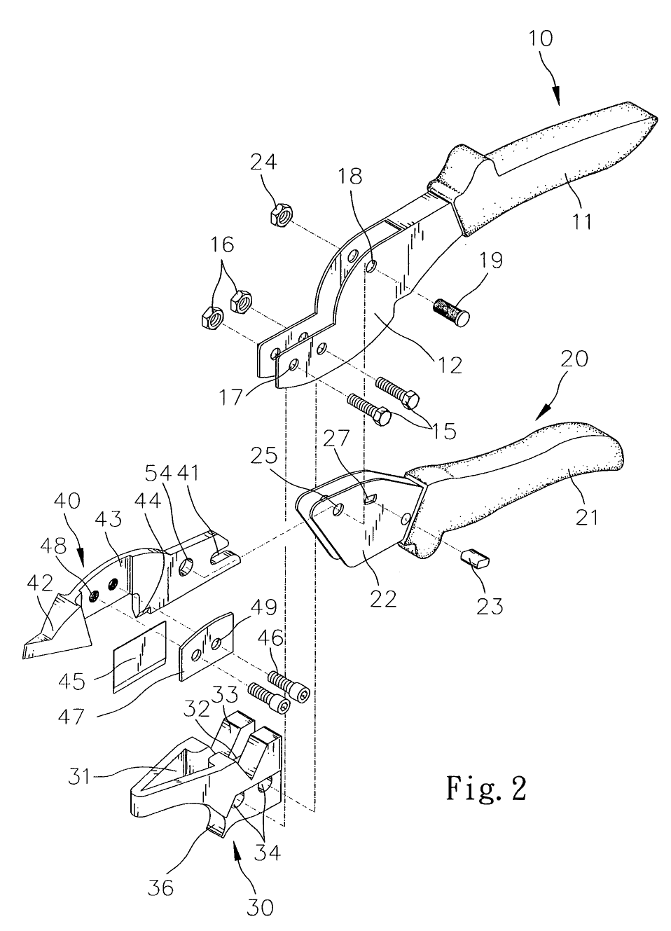

Referring to FIGS. 1 and 2, a cutting tool includes a first handle 10, a second handle 20, a first jaw 30, a second jaw 40, a cutting device and a shearing device.

The first handle 10 includes a grip 11 and two flat supports 12 extending from the grip 11. Each flat support 12 defines two apertures 17 and an aperture 18.

The second handle 20 includes a grip 21 and two flat supports 22 extending from the grip 21. Each flat support 22 defines an aperture 25 and a slot 27.

The first jaw 30 includes a hollow triangular shear 31 formed thereon, two holders 33 formed next to the hollow triangular shear 31 and a cutting board 35 formed next to the holders 33. The holders 33 are separated from each other by means of a groove 32. Two apertures 34 are defined in the first jaw 30. Each holder 33 defines a V-shaped recess (not numbered).

The second jaw 40 includes a triangular shear 42 formed thereon, a connecting section 43 formed next to the triangular shear 42 and a blade 44 formed next to the connecting section 43. An aperture 46 and a slot 41 are defined in the second jaw 40. The connecting section 43 includes two screw holes 48 defined therein.

The cutting device includes a fixing plate 47 and a knife 45. The fixing plate 47 includes two apertures 49 defined therein.

In assembly, the first jaw 30 is put between the flat supports 12 of the first handle 10. Two bolts 15 are inserted in the apertures 17 and 34. Each bolt 15 is engaged with a nut 16. Thus, the first handle 10 is firmly connected with the first jaw 30.

The second jaw 40 is put between the flat supports 22 of the second handle 20. A key 23 is fit in the slots 27 and 41. The flat supports 22 of the second handle 20 are put between the flat supports 12 of the first handle 10. A bolt 24 is inserted in the apertures 18, 25 and 46. The bolt 24 is engaged with a nut 26. Thus, the first handle 10 is pivotally connected with the second handle 20, and the second jaw 40 is connected with the second handle 20.

The knife 50 is put between the fixing plate 47 and the connecting section 43. Two bolts 46 are driven into the screw holes 48 through the apertures 49. Thus the knife 45 is firmly attached to the second jaw 40.

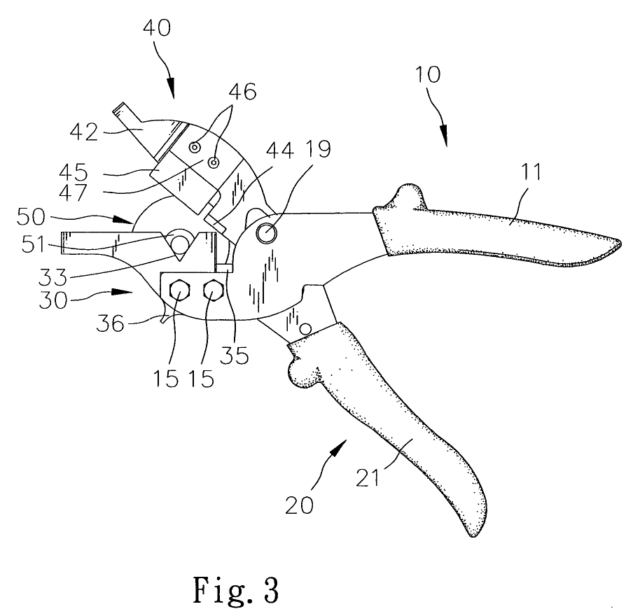

FIG. 3 shows the cutting tool ready for cutting a nozzle 51 of a tube 50 for containing silicone. The nozzle 51 is put in the V-shaped recesses of the holders 33. Then, the first handle 10 is pivoted towards the second handle 20. Accordingly, the first jaw 30 is moved towards the second jaw 40. Thus, the knife 45 cuts the nozzle 51 held by means of the holders 33.

Although not shown, a rod or wire can be put between the blade 44 and the cutting board 35. The first handle 10 can be pivoted towards the second handle 20. Accordingly, the first jaw 30 is moved towards the second jaw 40. Thus, the blade 44 cuts the rod or wire supported by means of the cutting portion 35.

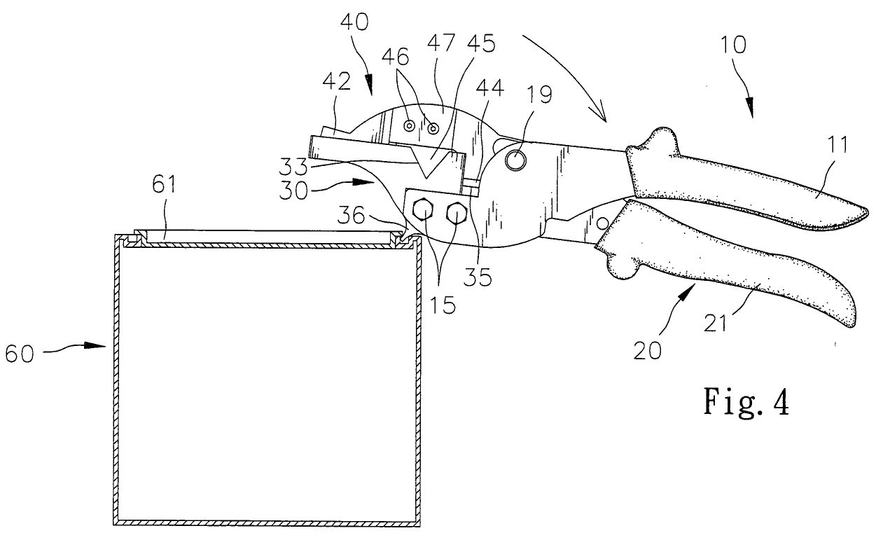

FIG. 4 shows the protrusion 36 inserted between a cap 61 and a rim of a can 60. Thus, when a user presses the first handle 10 and a second handle 20, the protrusion 36 can open the cap 61.

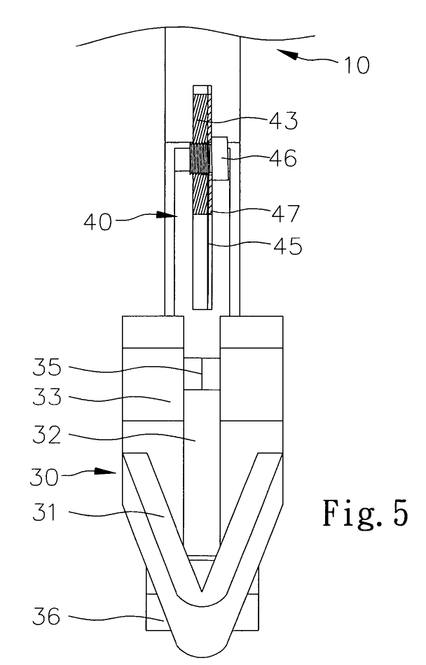

FIG. 5 shows the knife 45 firmly installed between the fixing plate 47 and the connecting section 43 by means of the bolts 46.

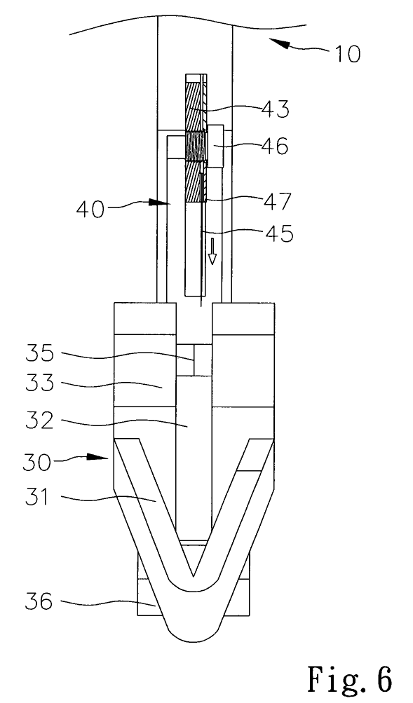

Referring to FIG. 6, the bolts 46 are unscrewed from the screw holes 48 so that the fixing plate 47 does not abut against the knife 45. Therefore, the knife 45 can be removed from the second jaw 40 for replacement with a new one.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

1. A cutting tool comprising a first handle, a second handle pivotally connected with the first handle, a first jaw secured to the first handle, a hollow shear formed on the first jaw, a second jaw secured to the second handle, a solid shear formed on the second jaw for cooperating with the hollow shear and a knife attached to the second jaw in a detachable manner.

2. The cutting tool according to claim 1 comprising a fixing plate for attaching the knife to the second jaw.

3. The cutting tool according to claim 2 comprising at least one bolt for driving the fixing plate towards the second jaw so as to clamp the knife.

4. The cutting tool according to claim 3 wherein the fixing plate defines at least one aperture for receiving the bolt, and the second jaw defines at least one screw hole for engagement with the bolt.

5. The cutting tool according to claim 1 comprising a protrusion extending from the first jaw.

6. The cutting tool according to claim 1 wherein the first jaw comprises two holders for holding an item to be cut by means of the knife.

7. The cutting tool according to claim 1 wherein the hollow shear is in the form of a hollow triangle, and the solid shear is in the form of a solid triangle.
